(19) United States
(12) Patent Application Publication
(10) Pub. No.: US 2012/0160781 A1
(43) Pub. Date: Jun. 28, 2012

(54) System for Treating Fine Tailings

(75) Inventor: Raymond Douglas D'Hollander, Fayetteville, NY (US)

(73) Assignee: PARSONS CORPORATION, Pasadena, CA (US)

(21) Appl. No.: 12/979,165

(22) Filed: Dec. 27, 2010

(51) Int. Cl. B09C 1/00; B01D 21/00

(52) U.S. Cl. 210/767; 210/513

(57) ABSTRACT

A method for treating fine tailings from bitumen extraction from oil sands in a tailings treatment zone and extracting the liquid from the fine tailings. The tailings treatment zone can contain a base layer, alternating layers of fine tailings and drainage media. The treatment zone can be prepared in multiple cells contained in a basin.

### BACKGROUND

Bituminous sands, or “oil sands” contain naturally occurring mixtures of sand, clay, water, and a dense and extremely viscous form of petroleum known as bitumen. The oil sands can be mined for bitumen, which can be further processed into synthetic oil or petroleum products. Because bitumen flows very slowly, if at all, toward producing wells under normal conditions, the sands are excavated by strip mining where depth allows. After excavation, hot water and/or a caustic chemical are added to the sand, and the resulting slurry is piped to an extraction plant where it is agitated. The combination of hot water and agitation releases bitumen from the oil sand, and allows small air bubbles to attach to the bitumen droplets. The bitumen froth floats to the top of separation vessels, and is further treated to remove residual water and fine solids. The bitumen extraction technique results in waste material that is made up of coarse sand and soft and unusable clay and silt-sized fine tailings.

Currently, waste material from mining operations is placed onto a sloping “beach” at one end of a pond. As the waste material fans out across the beach, most of the coarse sand quickly settles out and joins the beach. The remaining fine tailings join the pond contents. In the pond, the fine tailings are fully saturated with pore pressures that are equal to or greater than hydrostatic conditions. The high liquid content of the fine tailings results in a low bulk density of the fine tailings; the density is only slightly greater then the density of water. The combination of the low bulk density of the fine tailings and the hydrostatic conditions of the pond results in the pond having a very low buoyant unit weight and low in situ effective stress. Thus the fine tailings settle very slowly; typically many years are required to settle the fine tailings so that they become solid, or reach the liquid limit. Therefore, to strengthen the fine tailings and allow reclamation of the land, it is necessary to take additional measures to reduce the water content of the fine tailings to the required level.

Processes currently used to reclaim land containing fine tailings material include mixing the fine tailings with sand, and/or mixing the fine tailings suspension with a polymer flocculent, followed by spreading the mixture over a sloping beach. The drawbacks of the processes include: insufficient vertical pressure in the fine tailings to compress them the appropriate amount, decreased permeability of the fine tailings as they compress, and increasing drainage path length as the fine tailings accumulate so that the rate of consolidation decreases for the deeper materials.

It is desirable that the fine tailings are disposed of and the liquid in the fine tailings removed so that the fine tailings deposit area becomes trafficable and ready for reclamation. Exemplary of systems for removing water from fine tailings are described in U.S. Patent Application No. 2010/0006510 (Dymond et al.), U.S. Pat. No. 5,413,433 (Davies), and Canadian Patent Application No. 2,522,031 (Ozum). It is desirable to improve on these systems by removing water from fine tailings quickly and at low cost. Accordingly, there is a need for an improved method to treat fine tailings to reduce the water content of the fine tailings and reclaim the land the fine tailings are disposed on.

### SUMMARY

The present invention satisfies this need. The system includes a method for the treatment of fine tailings by reducing their water content to allow reclamation of fine tailings disposal areas. The method of the invention provides in-place settling and compaction of fine tailings, increased shear strength of the fine tailings, reduction in the volume of the fine tailings, and stabilization of fine tailings. The invention is particularly suitable for the disposal of fine tailings resulting from oil sands or mineral processing.

A method having features of the present inventions comprises the steps of: depositing in a tailings treatment zone a base layer, and depositing a first layer of fine tailings above the base layer. The first layer of fine tailings has a first thickness, an upper surface exposed to the atmosphere, and a bottom surface able to drain downwardly into the base layer. A first layer of drainage media is deposited on the upper surface of the first layer of fine tailings, the first layer of drainage media having a second thickness, the first thickness being at least twice the second thickness in order to minimize the storage volume and area dedicated to fine tailings and increase the quantity of tailings sand that can be used for other more beneficial purposes. Liquid is extracted from the first layer of fine tailings through the base layer, the drainage media layer, or both the base layer and drainage media layer.

Typically, the layer of fine tailings has a solids content of at least 10% by weight when deposited. The first thickness of the fine tailings typically is up to about 10 times the second thickness. The first layer of fine tailings can have a thickness from about 1 to about 10 metres, or from about 2 to about 5 metres. The first layer of drainage media can have a thickness of from about 0.2 to about 1 metre, or from about 0.3 to about 0.5 metre.

The base layer and/or the drainage media can include a drainage device such as piping.

The step of extracting the liquid can include pumping liquid from the drainage media so that the water pressure elevation in the base layer is below the upper surface of the first fine tailings layer. The step of extracting liquid can occur before, during, and/or after depositing the first layer of drainage media. Liquid can be extracted until the first layer of fine tailings has a solids content of at least the liquid limit, which is the moisture content at which soil begins to behave as a liquid material and begins to flow.

In one version of the invention, a second layer of fine tailings is deposited on the first layer of drainage media, and a second layer of drainage media is deposited on the second layer of fine tailings. In another version, additional alternating layers of fine tailings and drainage media are deposited in the tailings treatment zone.

Preferably the tailings treatment zone comprises multiple cells separated from each other by barriers. Fine tailings are processed in each cell by the steps of: 1) depositing the base layer of drainage media in the cell in stage one, optionally with a drainage device such as drainage pipes, 2) depositing the first layer of fine tailings above the base layer in stage two, 3) depositing the first layer of drainage media on the upper surface of the first layer of fine tailings in stage three, 4) repeating steps 2 and 3 at least one more time in stages four and five respectively, and 5) extracting liquid from the layers of fine tailings. It is contemplated that the sequence of the depositing steps between cells is controlled so that at least two of the cells are at different stages. It is also contemplated that fine tailings can continuously be deposited in the tailings treatment zone.

The tailings treatment zone can include at least three cells at different stages of processing. It is contemplated that each cell is adjacent to at least one other cell.

The present invention contemplates a tailings treatment system for removing water from fine tailings. The system contains a basin divided into multiple cells separated from each other by barriers, with means for depositing multiple alternating layers of fine tailings and drainage media in each cell in stages, such as a pump, with at least two of the cells being in a different stage. Preferably each cell is adjacent to at least one other cell.

### DRAWINGS

These and other features, aspects, and advantages of the present invention will become better understood with regard to the following description, appended claims, and accompanying drawings.

FIG. 1 schematically shows a fine tailings treatment system having features of the present invention;

FIG. 2 shows two cells containing fine tailings waste at different stages of treatment;

FIG. 3 shows the details of a cell having multiple layers; and

FIG. 4 shows the concurrent treatment activity in multiple cells.

### DESCRIPTION

As used herein, the following terms and variations thereof have the meanings given below, unless a different meaning is clearly intended by the context in which such term is used.

The terms “a,” “an,” and “the” and similar referents used herein are to be construed to cover both the singular and the plural unless their usage in context indicates otherwise.

The term “at least” followed by a number is used herein to denote the start of a range beginning with that number (which can be a range having an upper limit or no upper limit, depending on the variable being defined.) For example, “at least 1” means 1 or more then 1. When, in this specification, a range is given as “(a first number) to (a second number),” this means a range whose lower limit is the first number and whose upper limit is the second number. For example, 1 to 10 meters means a range whose lower limit is 1 meter, and whose upper limit is 10 meters.

The term “barrier” refers to a structure which separates one area from another area. A barrier can be made out of any material which allows for the separation of areas. For example, a barrier can be made out of course sands.

As used herein, the term “comprise” and variations of the term, such as “comprising” and “comprises,” are not intended to exclude other additives, components, integers or steps.

The term “continuous” means at least 24 hours.

This invention is directed to processing solid materials resulting from mining operations. Generally, the particles resulting from oil sands processing and other mining operations are referred to as “tailings.” They can be divided into coarse material and fine material, often using a mesh of about 44 micrometers. The term “fines” refers to the fine material portion of the tailings solids. When the solids are predominantly the fine material portion of the tailings, they are referred to as “fine tailings.” “Consolidated tailings” contain a mixture of fine tailings and sand.

The term “drainage media,” as used herein, refers to any material that drains water faster than water drains from fines, and typically is the coarse material resulting from dividing up the solids, such as sand.

As used herein, the term “liquid limit” is one of the Atterberg limits and refers to the moisture content at which soil begins to behave as a liquid material and begins to flow. The liquid limit of a soil and its water content can be used to express its relative consistency or liquidity index. Measurement of the liquid limit correlates with behavior such as compressibility, hydraulic conductivity (permeability), compactability, shrink-swell, and shear strength of the soil. The liquid limit can be measured by ASTM Standard Test Method D4318.

The phrase “water pressure elevation” refers to a specific measurement of water pressure above a geodetic datum. It is usually measured as a water surface elevation, expressed in units of length, at the entrance (or bottom) of a piezometer.

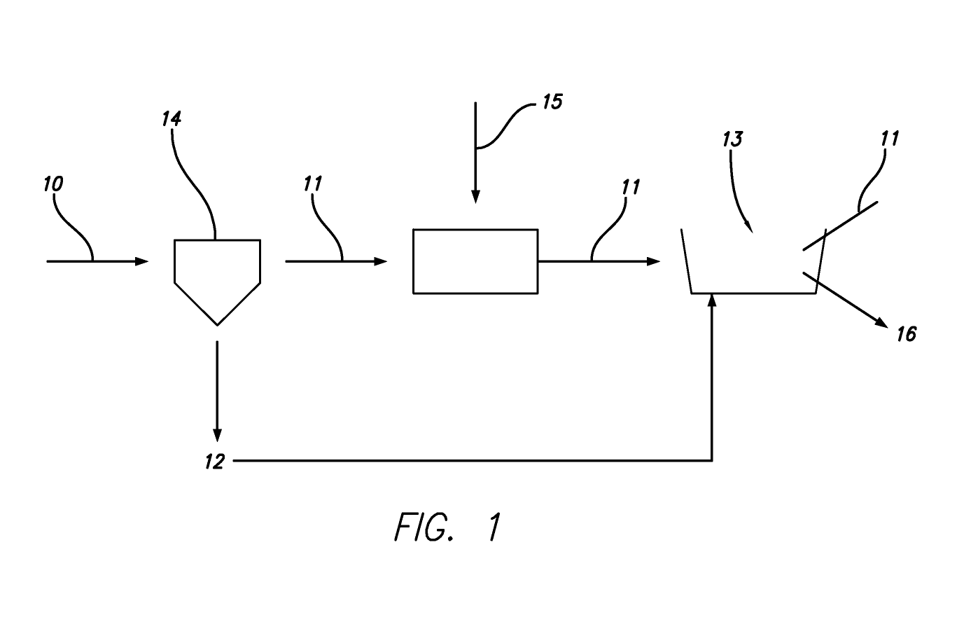

A process having features of the present invention is shown in FIG. 1. A typical system for bituminous sands processing begins with separation of the consolidated tailings 10 from the mining process into fine tailings 11 and coarse sand 12. The coarse sand 12 can be re-used as drainage media in the tailings treatment zone 13.

Before the fine tailings 11 are added to the tailings treatment zone 13, the fine tailings 11 can be separated from the consolidated tailings 10 by means well known in the art, such as for example, a hydrocyclone 14. Alternatively, or in addition to passing through a hydrocyclone 14, the fine tailings 11 can be treated with additives 15 to thicken the fine tailings 11. One such treatment is a thickening agent such as a polymer or a flocculent.

After additives 15 are added to the fine tailings 11, the thickened fine tailings 11 are placed in the tailings treatment zone 13. The tailings treatment zone 13 is an area where liquid 16 is removed from the fine tailings 11 to allow reclamation of fine tailings 11 disposal areas. The liquid from the fine tailings 11 is extracted in situ, and the volume of the fine tailings 11 is reduced without further handling of the fine tailings 11. The tailings treatment zone 13 provides in-place settling and compaction of fine tailings 11, increases the shear strength of the fine tailings 11, reduces the volume of the fine tailings 11, and stabilizes the fine tailings 11.

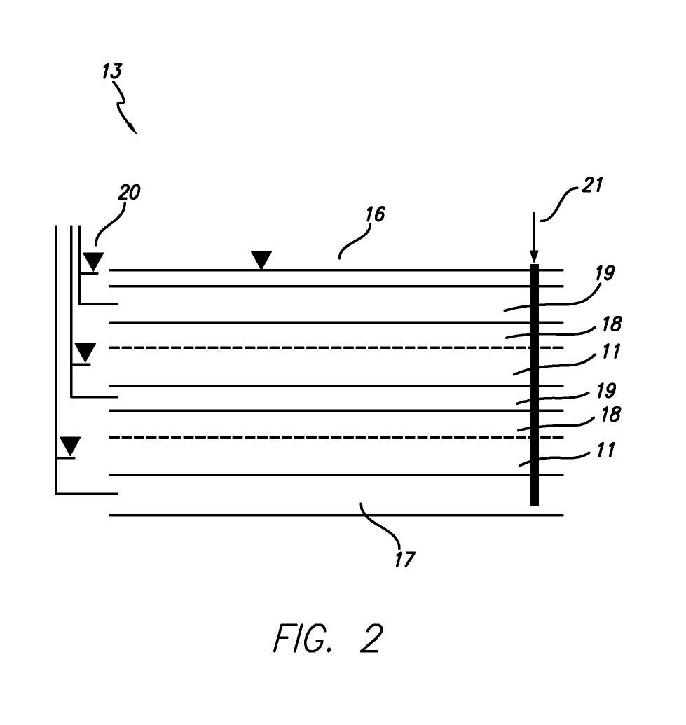

The fine tailings 11 are layered on top of a base layer 17 in the tailings treatment zone 13, as shown in FIG. 2. The base layer 17 can be at the bottom and/or sides of the tailings treatment zone 13. The base layer 17 can contain drainage media 19. The drainage media 19 can comprise imported sand or gravel or sand that has been separated from the consolidated tailings 10 by the hydrocyclone 14. Other drainage media, such as geosynthetic drainage composites, can also be used.

The thickness of the first layer of fine tailings 11 can be used to regulate the rate of consolidation. Liquid 16 can be extracted more quickly from a thin layer of fine tailings 11 as compared to a thicker layer of fine tailings 11.

The solids content of the fine tailings 11 deposited in the tailings treatment zone 13 can be any amount less then the liquid limit. The process described herein is intended to increase the solids content of the fine tailings 11 to over 10%

After the fine tailings 11 layer has been deposited in the tailings treatment zone 13, the upper surface 18 of the fine tailings 11 is exposed to the atmosphere. During that time, the upper surface 18 undergoes dewatering measures such as desiccation in the summer or freeze-thaw in the winter. Both of these methods reduce liquid content and increase the shear strength of the fine tailings 11.

After exposure to the atmosphere, a layer of drainage media 19 is added on the upper surface 18 of the first layer of fine tailings 11. The purpose of the drainage media 19 layer is to reduce the amount of liquid within the fine tailings 11. As shown in FIG. 2, there is liquid 16 on top of the layer of drainage media 19. As the liquid 16 is removed from the drainage media 19, the liquid levels 20 are reduced, as shown on the left side of FIG. 2.

It is contemplated that two or more alternating fine tailings 11 and drainage media layers 19 can be placed in the tailings treatment zone 13. The plurality of layers can accelerate dewatering of the fine tailings and provide increased strength as well as increased volume reduction of the fine tailings 11 material.

The thickness of the fine tailings 11 and drainage media 19 layers can vary. Preferably, the thickness of the fine tailings 11 layer is two to ten times the thickness of the drainage media layer 19.

The means for depositing multiple alternating layers of fine tailings 11 and drainage media 19 in each cell 1 can be any means known by those of skill in the art. For example, means for depositing the layers into a cell 1 can be achieved by a boom, by a pump, by gravity feed, by a barge, or by flooding the cells.

Liquid can be extracted actively and/or passively from the top and/or bottom of the fine tailings 11 layer by a drainage device in the drainage media 19. Removal of liquid 16 from both the top and bottom of the fine tailings 11 layer shortens the drainage path for the liquid 16, which allows for faster settling of fine tailings 11 than if liquid is removed from only one side of the fine tailings 11.

Passive removal of liquid 16 can be achieved by any means including, for example, drainage devices such as wick drains, polymeric products such as geonets or geomembranes or other permeable media.

Active removal of liquid 16 is well known in the art and can be achieved by any means including, for example, pumping liquid out of the base layer 17 and/or drainage media 19 through drainage devices such as drainage pipes placed in the tailings treatment zone 13. Drainage pipes can be located horizontally in the drainage media 19 layer, in the base layer 17, and/or placed vertically in the tailings treatment zone 13. The drainage pipes can be made from any material that can be used to carry liquid such as, for example, high-density polyethylene (HDPE) piping (Cleveland Tubing, Cleveland, Tenn.). The drainage pipes can contain small holes so that the fine tailings 11 base layer 17, and drainage media 19 materials do not plug the holes.

Active removal of the liquid 16 increases the efficiency of liquid extraction, reduces the water pressure elevation in the base layer 17 and drainage media layers 19 thus reducing hydrostatic stress which increases the effective stress within the fine tailings 11, as well as shortening the drainage path of the liquid 16. Increased effective stress increases strength of the fine tailings 11. Active removal thus increases and accelerates consolidation of the fine tailings 11 in the tailings treatment zone 13.

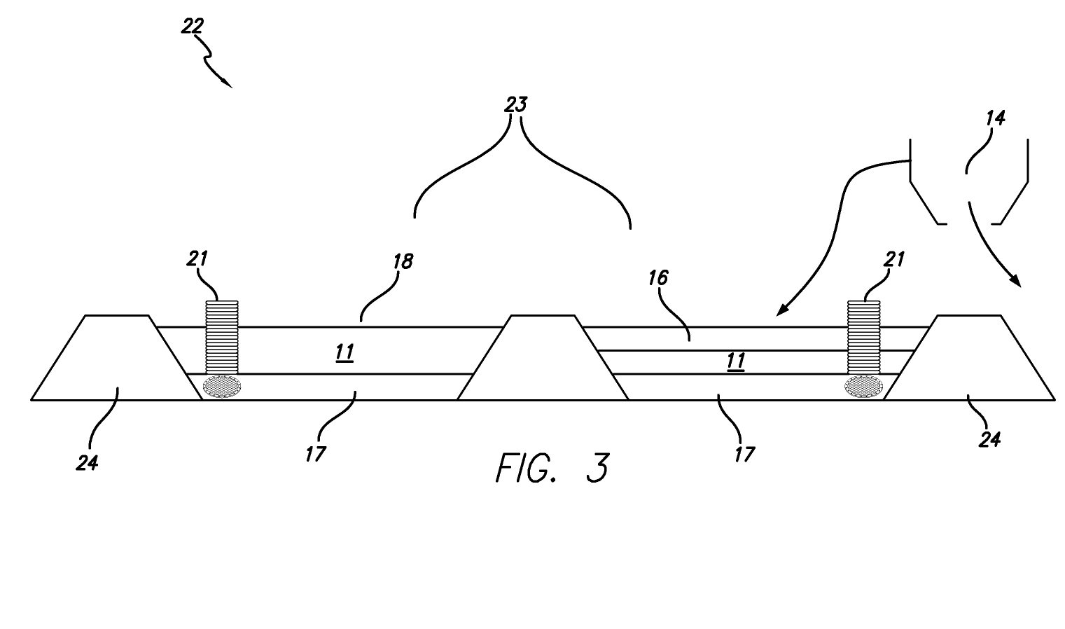

In addition, optional vertical drainage channels 21 can be inserted in the tailings treatment zone 13, as shown in FIGS. 2 and 3. The vertical drainage channels can comprise a well or manhole measuring 12 to 48 inches in diameter with either a cap or a slotted screen in the base layer 17. The vertical drainage channels can also comprise drainage media 19 and/or drainage devices. Liquid 16 can be extracted from the fine tailings 11 from the vertical drainage channels using the methods described above for the drainage media 19 layer.

The liquid 16 can be extracted from the base layer 17 and drainage media 19 so that the water pressure elevation in the base layer 17 is below the surface of the first fine tailings 11 layer.

Preferably the liquid 16 is extracted from the fine tailings 11 until the fine tailings 11 has a solids content of at least the liquid limit. As described above, the liquid limit is defined as the moisture content at which soil begins to behave as a liquid material and begins to flow. The liquid limit can be measured by ASTM Standard Test Method D4318.

The liquid 16 removed from the fine tailings 11 treatment zone can be used as process water for use in the mining and/or ore processing operation. For example, water removed from fine tailings 11 resulting from the removal of bitumen from oil sands can be re-used as process water for bitumen extraction.

Currently, fine tailings 11 ponds are designed as a single large pond. The system contemplated herein is shown in FIG. 3 and contains a basin 22 divided into multiple cells 23 separated from each other by barriers 24. The basin 22 can be dry, or can contain water such that the uppermost layer in the tailing treatment zone is covered. There is a means for depositing multiple alternating layers of fine tailings 11 and drainage media 19 in each cell 1 in stages, with at least one of the other cells being in a different stage. In the tailing treatment cell 1 on the left, the fine tailings 11 surface is exposed to the atmosphere. The tailing treatment zone on the right shows fine tailings 11 being deposited on top of the base layer 17 after being separated from the consolidated tailings 10 by a hydrocyclone 14.

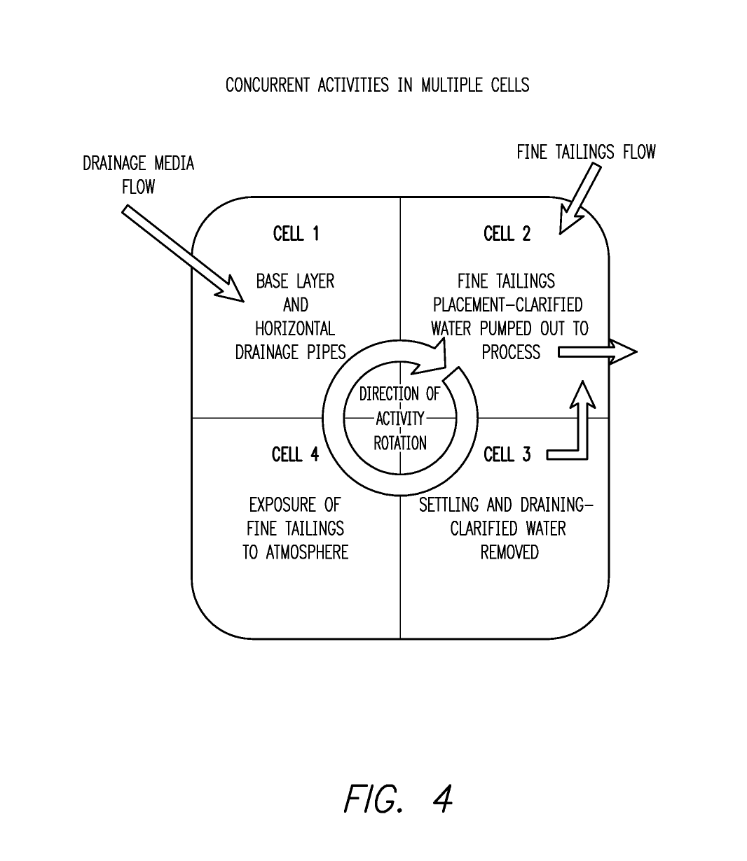

The fine tailings 11 treatment method can be ongoing in two or more cells, with the cells at different stages of processing. For example, FIG. 4 shows four cells in different processing stages. Cell 1 shows the placement of a layer of drainage media 19 and a horizontal drain, with an arrow from outside the Cell 1 indicating the flow of the drainage media 19 into the Cell 1. Placement of the fine tailings 11 layer is shown in Cell 2, with an arrow from outside the Cell 2 indicating the flow of the fine tailings 11. Cell 2 also shows an arrow depicting the flow of clarified liquid 16 outside of the Cell 2. Cell 3 shows the treatment stage of settling and removal of the clarified liquid 16. While materials are settling in Cell 3, liquid 16 can be removed from the materials and placed into the adjacent Cell 2 for additional clarification. Cell 4 shows the exposure of the surface of the fine tailings 11 to the atmosphere. The center arrow indicates the direction of the rotation of activities to a different stage of treatment in each of the cells.

The use of multiple cells 23 allows an ongoing continuous operation where different cells are in different stages of rotation as described above. This allows for continuous discharge of fine tailings 11 from the mining process at all times. The number of cells in the pond is dictated by the amount of time the cells spend in each stage of the treatment process.

The timeframe of the rotation of the cells is variable depending on the size of the cells, the rate that the material is placed, and how fast the liquid is removed from the fine tailings 11. For example, placement of the drainage media 19 in Cell 1 can take from two weeks to six months. Cell 2 can be actively receiving fine tailings 11 material for three to six months. Settling and draining of the clarified liquid 16 in Cell 3 can occur over one to six months. Cell 4 can be exposed to the atmosphere for three to six months.

The size of the cells can vary based on factors such as the amount of fine tailings 11 that are added to the fine tailings 11 layer over a period of time, as well as the liquid content of the fine tailings 11.

The cells can be built inside or outside of a mine pit. If built inside the mine pit, the cells could be covered in situ as a part of the process of closing a mine.

Among the advantages of the method described herein include the treatment of the fine tailings 11 in one area, namely the tailings treatment zone 13. As such there is no required re-handling of the fine tailings 11 which makes treatment of the fine tailings 11 more efficient and economical. In addition, the methods reduce and stabilize fine tailings 11 from mining processes, which reduces the consolidation time and increases the strength of fine tailings 11 so that land containing the fine tailings 11 waste can be quickly restored and reclaimed. Furthermore, the described method increases the extraction of water from the fine tailings 11, which can then be recycled and used as process water for the mining operation. The lower water pressure elevations in the pond should also decrease discharge of water to the underlying geologic formation which can reduce migration of pollutants from the pond. This in turn increases socially and environmentally responsible mining operations and meets government policy to affect the timely reclamation of fine tailings 11.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

What is claimed is:

1. A method for treating fine tailings, the method comprising the steps of:
a. depositing in a tailings treatment zone a base layer;
b. depositing a first layer of fine tailings above the base layer, the first layer of fine tailings having a first thickness, the first layer having an upper surface exposed to the atmosphere and a bottom surface able to drain downwardly into the base layer;
c. depositing a first layer of drainage media on the upper surface of the first layer of fine tailings, the first layer of drainage media having a second thickness, the first thickness being at least twice the second thickness; and
d. extracting liquid from the first layer of fine tailings from the base layer, the drainage media layer or both the base layer and drainage media layer.

2. The method of claim 1, wherein the fine tailings have a solids content of at least 10% by weight.

3. The method of claim 1, wherein the first thickness is up to about 10 times the second thickness.

4. The method of claim 1, wherein the base layer includes a drainage device.

5. The method of claim 1, wherein the layer of drainage media comprises a drainage device.

6. The method of claim 1, wherein the step of extracting comprises pumping liquid from the drainage media so that the water pressure elevation in the base layer is below the surface of the first fine tailings layer.

7. The method of claim 1, wherein the step of extracting liquid occurs before, during, and/or after depositing the first layer of drainage media.

8. The method of claim 1 comprising after step (c) depositing a second layer of fine tailings on the first layer of drainage media, and thereafter depositing a second layer of drainage media on the second layer of fine tailings.

9. The method of claim 1 comprising repeating steps (b) and (c) at least twice so that the tailings treatment zone contains at least three sets of alternating layers of fine tailings and drainage media.

10. The method of claim 1, wherein the step of extracting comprises extracting liquid until the first layer of fine tailings has a solids content of at least the liquid limit.

11. The method of claim 1, wherein the first layer of fine tailings has a thickness from about 1 to about 10 metres.

12. The method of claim 11, wherein the first layer of fine tailings has a thickness from about 2 to about 5 metres.

13. The method of claim 1, wherein the first layer of drainage media has a thickness of from about 0.2 to about 1 metres.

14. The method of claim 13, wherein the first layer of drainage media has a thickness of from about 0.3 to about 0.5 metres.

15. A method of removing liquid from fine tailings comprising the steps of:
a) preparing a tailings treatment zone comprising multiple cells separated from each other by barriers;
b) processing fine tailings in each cell by the steps of:
(i) depositing a base layer comprising drainage pipes in the cell in stage one;
(ii) depositing a first layer of fine tailings above the base layer having a first thickness in the cell in stage two, the first layer having an upper surface exposed to the atmosphere;
(iii) depositing a first layer of drainage media on the upper surface of the first layer of fine tailings in stage three, the first layer of drainage media having a second thickness;
(iv) repeating steps (b(ii)) and (b(iii)) at least one more time in stages four and five respectively; and
(v) extracting liquid from the layers of fine tailings; and
(c) controlling the sequence of the depositing steps between cells so that at least two of the cells are at different stages.

16. The method of claim 15, wherein the tailings treatment zone comprises at least 3 cells, and wherein the step of controlling comprises controlling the sequence of the depositing steps between cells so that at least three of the cells are at different stages.

17. The method of claim 15, wherein the first thickness is at least twice the second thickness.

18. The method of claim 15, wherein each cell is adjacent to at least one other cell.

19. The method of claim 14, wherein the step of controlling the sequence of the depositing steps comprises continuous depositing of fine tailings.

20. A method of treating fine tailings resulting from a process for recovering bitumen from oil sand, the method comprising the steps of:
(a) providing a basin;
(b) providing multiple cells in the pond, each cell having a base layer and side base layers, each cell being adjacent to at least one other cell;
(c) processing fine tailings in each cell by layering alternating amounts of fine tailings and drainage media inside the cell, comprising the steps of:
i. depositing a layer of fine tailings having a first thickness;
ii. exposing the surface of each fine tailings layer to the atmosphere;
and
iii. depositing a layer of drainage media on top of the layer of fine tailings, wherein the drainage layer contains drainage media, the layer of drainage media having a second thickness, the first thickness being at least twice the thickness of the second thickness;
(d) extracting liquid from the fine tailings layer; and
(e) controlling the sequence of the depositing steps between cells so that at least two of the cells are at different steps of processing.

21. The method of claim 20, wherein the fine tailings have a solids content of at least 10% by weight.

22. The method of claim 20, wherein the first thickness is up to about 10 times the second thickness.

23. The method of claim 20, wherein the base layer includes a drainage device.

24. The method of claim 20, wherein the step of extracting comprises pumping liquid from the base layer.

25. The method of claim 20, wherein the step of extracting comprises extracting liquid until the first layer of fine tailings has a solids content of at least the liquid limit.

26. A tailings treatment system for removing water from fine tailings comprising:
a) a basin divided into multiple cells separated from each other by barriers;
b) means for depositing multiple alternating layers of fine tailings and drainage media in each cell in stages;
c) a first layer of fine tailings in a first cell with a first layer of drainage media on top of the first layer of fine tailings; and
d) at least one of the other cells being in a different stage.

27. The system of claim 26, wherein the means for depositing multiple alternating layers of fine tailings and drainage media is a pump.

28. The system of claim 26, wherein the layer of fine tailings is thicker then the layer of drainage media.

29. The system of claim 28, wherein the layer of fine tailings is at least twice the thickness of the layer of drainage media.

30. The system of claim 26, wherein the cells are adjacent to at least one other cell.

31. The system of claim 26 comprising a base layer in each cell.

32. The system of claim 31, wherein the base layer further comprises drainage means in each cell.

33. The system of claim 32, wherein the drainage means comprises horizontal pipes.
